(19) United States
(12) Patent Application Publication
(10) Pub. No.: US 2005/0021680 A1
(43) Pub. Date: Jan. 27, 2005

(54) System and method for interfacing TCP offload engines using an interposed socket library

(76) Inventors: Pete Ekis, Santee, CA (US); Charles L. McKnett, Rancho Santa Fe, CA (US); Gregory Randal Ralph, San Diego, CA (US); Allen Andrews, El Cajon, CA (US); Caroline Augustine, Encinitas, CA (US)

Correspondence Address: PAUL, HASTINGS, JANOFSKY & WALKER LLP, P.O. BOX 919092, SAN DIEGO, CA, 92191-9092, US

(21) Appl. No.: 10/844,665

(22) Filed: May 12, 2004

Related U.S. Application Data
(60) Provisional application No. 60/469,742, filed on May 12, 2003.

(51) Int. Cl. G06F 15/16

(52) U.S. Cl. 709/219

(57) ABSTRACT

A system and method for interfacing TCP Offload Engines (TOE) into an operating system to improve system performance and reduce CPU utilization. The system and method places an interposed filter before the generic user space socket library near the top of the TCP stack to intercept at the earliest possible layer a user application network socket request. The interposed filter determines whether an I/O request is targeted for a generic network adapter or a full TOE network adapter. For I/O requests that are targeted to a full TOE network adapter, the request is formatted to meet the requirements of the full TOE driver and sent directly to that driver, bypassing the operating system's generic user space socket library and socket driver in kernel space. This system and method takes full advantage of the capabilities offered by TOE hardware.

### RELATED APPLICATIONS INFORMATION

1. Cross Reference to Related Applications

This application claims the benefit under 35 U.S.C. § 119(e)(1) of the Provisional Application filed under 35 U.S.C. § 111(b) entitled “INTERFACE OF TCP OFFLOAD ENGINES USING AN INTERPOSED SOCKET LIBRARY,” Ser. No. 60/469,742, filed on May 12, 2003. The disclosure of the Provisional Application is fully incorporated by reference herein.

### BACKGROUND

2. Field of the Inventions

The invention relates generally to computer networks and more particularly to a method for improving system performance and reducing system central processing unit utilization used in conjunction with a device driver for an offload TCP engine network adapter.

3. Background

The development of a layered software architecture has led to efficient data transfer networks and further investment into pioneering I/O bandwidth technologies. In recent years, computer networking I/O technology bandwidth has advanced at a much faster rate than the processing speeds of the host central processing units (CPUs) that run the host based TCP/IP driver stacks used to interface the computer to the network through the NIC. These advances in bandwidth have resulted in extremely high server CPU usage rates for NIC I/O processing, sometimes approaching CPU usage rates of 100% at 1 Gb/sec Ethernet speeds. With all the processing capabilities directed to I/O processing, application processing slows down requiring costly additions of CPU resources.

The industry solution has been to offload all or part of the TCP/IP stack onto the NIC hardware to relieve the host CPU of the I/O burden. Several vendors have introduced or announced the availability of TCP Offload Engines (TOE) NIC hardware solutions. In these new pieces of hardware, TOE components can be integrated onto a circuit board, such as a NIC, to process I/O and remove some of the I/O burden from the CPU, thus increasing throughput on the network. As these networking adapters are becoming more and more complex, moving more of the functionality down from the operating system to the controller itself, the problem of where to connect the networking driver into the existing host networking stack becomes extremely important.

In the case of full TOE network adapters, the entire Logical Link Control (LLC) and TCP code is contained on the adapter itself. If the network adapter was interfaced in the standard way, each request would, in essence, be processed by both the existing host networking stack and the networking stack of the TOE, canceling most of the performance advantages offered by full TOE network adapters.

The method of interfacing a TOE network adapter into the operating system prescribed by the prior art involves creating a filter driver to intercept requests and redirect the requests to the adapter, thereby bypassing part of the host networking stack. This filter service strategy works well for some operating systems, particularly Microsoft's Windows® based operating systems, but falls apart on many of today's high end operating systems, for example Sun Microsystems' Solaris®, which do not allow filter drivers to be inserted between all layers of the networking stack. In these cases, it is not possible to insert a filter driver at the top of the kernel socket module. A conventional method for interfacing of a TOE network adapter to the operating system requires inserting a filter driver at the bottom of the TCP stack as shown in FIG. 1. More specifically, FIG. 1 illustrates the path a user application network socket request 101 can take to reach a network line 120. The request 101 passes through a user space sockets library 102, a system trap table 104, and a kernel TCP/IP driver 106 prior to reaching a TCP offload filter driver 108 where it is determined whether a generic network adapter 114 or a TCP offload network adapter 116 is present in the computer system. This method is not desirable because the kernel's TCP/IP driver 106 continues processing requests and, if a TOE network adapter is present, the TCP offload network interface driver must discard at least part of the TCP work already done in order to present requests to the TCP offload engine network adapter 116 into the proper format. This approach obviously negates at least part of the benefits gained by offloading the TCP processing because the host networking stack continues the TCP processing, loading the host CPU with I/O processing requests.

Ultimately, networks should perform in a manner equivalent to the capabilities currently realized by the host computer. Therefore, a method is needed that will improve system performance and reduce CPU utilization when used in conjunction with a device driver for a full offload TCP engine. The present invention, as described in detail below, solves this problem by presenting a method for interfacing TCP Offload Engines into an operating system, including full offload TOEs that place all or most of the TCP processing in hardware and so called partial TOEs that attempt to utilize a portion of the operating system TCP/IP stack in conjunction with the hardware accelerated TOE.

### SUMMARY OF THE INVENTION

In order to combat the above problems, the systems and methods described herein provide for interfacing TCP Offload Engines (TOE) into an operating system to improve system performance and reduce CPU utilization by placing an interposed filter before the generic user space socket library near the top of the TCP stack to intercept at the earliest possible layer a user application network socket request. Thus, in one embodiment, a method is provided for processing network requests received by a computer including first intercepting the transmitted requests at an interposed socket library that is located between a user application program and a user space socket library. The interposed socket library then processes the request to determine if the request is directed to a generic network adapter or a TCP offload engine network adapter. If the request is directed to a TCP offload engine network adapter, the request is sent to the TCP offload engine network adapter for processing, thus bypassing the computer's central processing unit and significantly increasing the computer system's performance. If the request is directed to a generic network adapter, the request is processed by the user space socket library. Thus, the system and method described herein take full advantage of the capabilities offered by TOE hardware.

### BRIEF DESCRIPTION OF THE DRAWINGS

Preferred embodiments of the present inventions taught herein are illustrated by way of example, and not by way of limitation, in the figures of the accompanying drawings, in which:

FIG. 1 is a block diagram of a conventional system configured to interface a TCP offload engine network adapter into an operating system via a user space socket library;

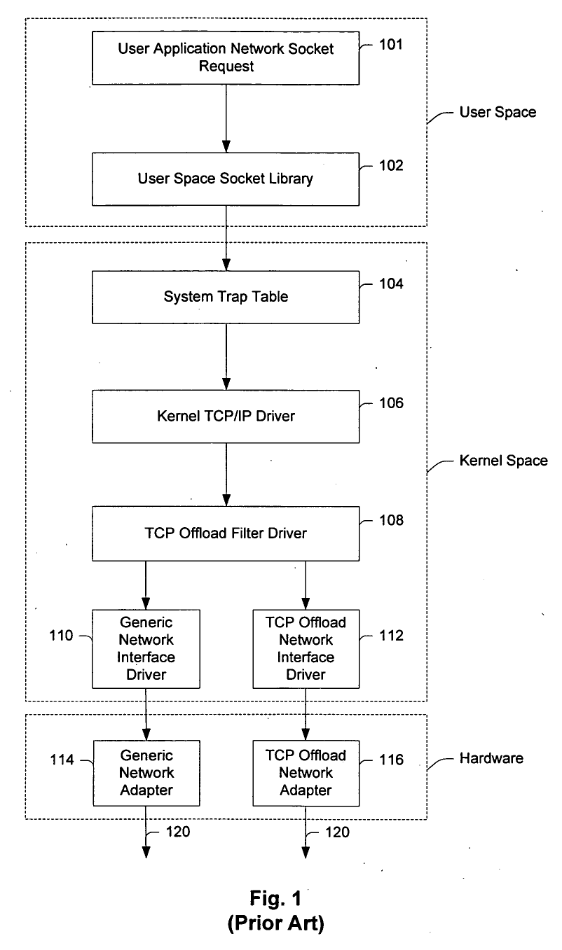

FIG. 2 is a block diagram of a system configured to interface a TCP offload engine with an operating system through the implementation of an interposed socket library;

FIG. 3 is a block diagram of a system configured to interface a partial TCP offload engine with an operating system through the implementation of an interposed filter; and

FIG. 4 is a flow chart illustrating the process flow of the present invention with respect to an exemplary “Listen” request transmitted from a user application program.

### DETAILED DESCRIPTION OF THE PREFERRED EMBODIMENTS

In the descriptions of example embodiments that follow, implementation differences, or unique concerns, relating to different types of systems will be pointed out to the extent possible. But it should be understood that the systems and methods described herein are applicable to any type of network system.

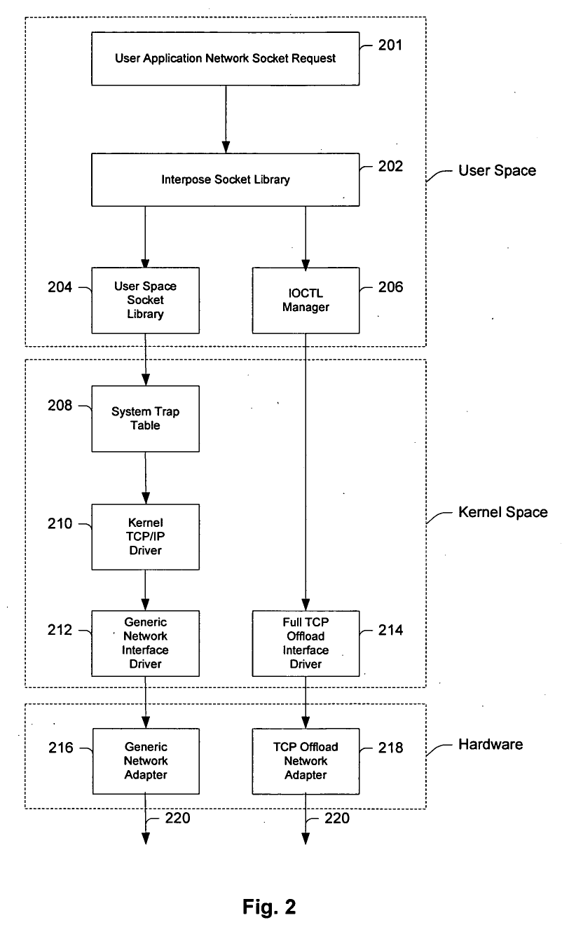

FIG. 2 is a block diagram of a system configured to interface a TCP offload engine with an operating system by implementing an interposed socket library in the user space, wherein the interposed socket library intercepts user application requests and determines whether the request is directed to a generic network adapter or a TCP offload engine network adapter. Specifically, a user space application sends a user application network request 201 to user space socket library 204. As opposed to conventional systems, the user application network request 201 is intercepted by an interposed socket library 202. The interposed socket library 202 is optimally placed prior to the user space sockets library, thus ensuring that requests 201 are intercepted at the earliest possible layer. Once the request 201 is intercepted, the interposed socket library 202 examines each request 201 to determine whether the target hardware is a generic network adapter 216 or a full TCP offload network adapter 218.

In one embodiment, interposed socket library 202 exists in the user space as a dynamically linked library. In another embodiment, interposed socket library 202 exists in user space as a shared object module. When a user application program is executed at runtime, the operating system loads the user application binary software into the user memory space. Since the application software files only contain the code for the application itself, the operating system also searches for code which supports the function calls that the application fails to provide. All the code must be dynamically gathered or loaded into the user memory space at the time the application is run so that when the code is executed every line of code that is needed to run the program is present in memory. When the operating system searches for a specific function, it scans every library file in every directory until the specific function is found. A list of directories to search is provided by an environment variable which is initialized by a configuration file. To interpose an existing operating system function, a new library file is created that contains the code labeled with the same function name as the operating system function. The new library file is then placed in a directory and the directory name is added to the library search list. As long as the new directory name is listed ahead of the original operating system directory in the list, the programmer is guaranteed that the new library file will be scanned before the original operating system library file. Thus, the new function code will be loaded into the application's user space instead of the original operating system function code.

In summary, the interposed socket library 202, once loaded, becomes part of the application in the user space above the TCP/IP stack residing in the kernel space. A corresponding interposed kernel program resides in the kernel space along side the TCP/IP stack functionally replacing the stack. As is explained in greater detail below, the interposed socket library is functionally configured to intercept the application program's calls to the TCP/IP stack and instead passes the request directly to the interposed kernel program, thus bypassing the TCP/IP stack in its entirely.

Returning now to FIG. 2, if the interposed socket library 202 determines that a request 201 is targeted to a generic network adapter 216, the request 201 is immediately passed to the user space socket library 204 without any modifications. The user space socket library 204 then sends the request 201 to system trap table 208 which forwards the request 201 to kernel TCP/IP driver 210. The kernel TCP/IP driver 210 configures the request 201 into a format understandable by the generic network interface driver 212. The generic network interface driver 212 then transmits the formatted request 201 to the generic network adapter 216. Upon receipt by the generic network adapter 216, the request is transmitted to network line 220.

If, however, the interposed socket library 202 determines that the request 201 is directed to the full TCP offload network adapter 218, the request 201 is formatted into a custom I/O control call (IOCTL) by interposed socket library 202. The IOCTL is a standard customizable message passing interface between the user space and the kernel space which provides an effective means for a user program and a kernel program to pass message buffers back and forth. The interposed socket library 202 then passes the formatted request to the IOCTL manager 206, which ensures formatting has occurred and handles delivering the request from the user program to the kernel program. For example, the IOCTL manager 206 may review the formatted request 201, having an address, by using parameters passed to the function and building an IOCTL message packet that contains the same parameters. On the other hand, for those requests with no specified address, the, request may be passed to the user space socket library for further processing. Optimally, the IOCTL supports at least the following functions:
socket, socketpair, bind, listen, accept, connect, close, shutdown, read, recv, recvfrom, recvmsg, write, send, sendmsg, sendto, getpeername, getsockname, getsockopt, setsockopt

The newly formatted IOCTL message packet is then transmitted to the full TCP offload interface driver 214, thus bypassing both the generic user space sockets library 214 and generic network interface driver 212 in kernel space. The full TCP/IP offload interface driver 214 extracts the request 201 from the IOCTL message packet and transmits the request 201 to the TCP offload network adapter 218. The request may then be sent to network line 220.

The interposition of the interposed socket library before the user space socket library does not result in a measurable degradation in performance for socket requests to generic network adapters. However, for those requests directed to full TCP offload engines, this methodology allows the generic user space socket library 204, the generic network interface driver 212, and the kernel TCP/IP driver 308 to be entirely bypassed, thus resulting in a significant performance increase.

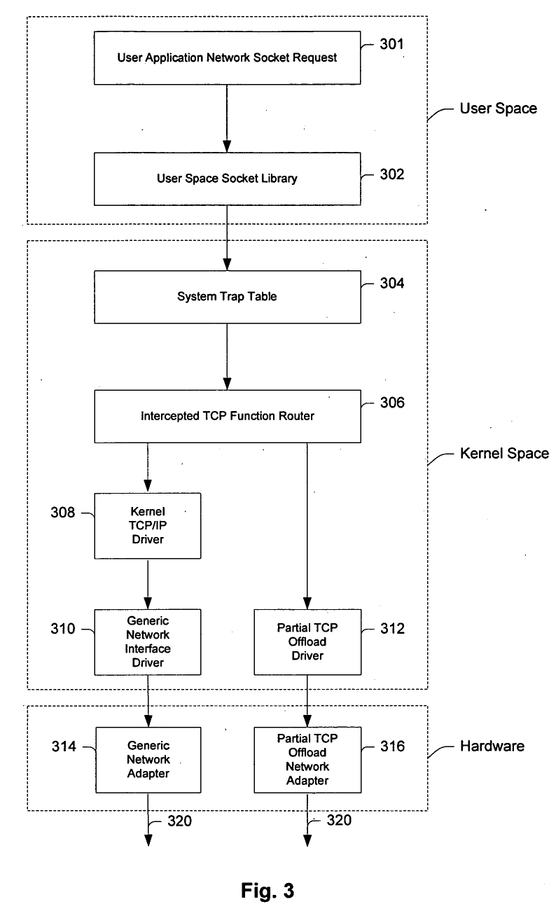

FIG. 3 is a block diagram of a system configured to interface a partial TCP offload engine network adapters into an operating system through the implementation of an interpose filter. To begin, the user space application sends a request, as depicted by the user application network socket request 301, to user space socket library 302. The request is then forwarded to system trap table 304. The system trap table 304 operates as a memory buffer containing a list of kernel function addresses used to transfer the user application network socket request 301 from a user space into a kernel space.

The transferred request 301 is transmitted from the system trap table 301 to an intercepted TCP function router 306, also referred to herein as an interpose filter. The intercepted TCP function router 306 operates as a filter driver by examining the IP address of each socket request 301 to determine whether the request 301 is directed to a generic network adapter 314 or a partial TCP offload network adapter 316.

If intercepted TCP function router 306 determines that request 301 is targeted to a generic network adapter 314, the request 301 is immediately passed to the kernel TCP/IP driver 308 without modification. The kernel TCP/IP driver 308 configures the request 301 in a format understandable by the generic network interface driver 310. The generic network interface drive then passes the request 301 to the generic network adapter 314. The request 301 is ultimately transmitted to network line 320.

If, however, the intercepted TCP function router 306 determines that a request is targeted to a partial TCP offload network adapter 316, the request 301 is sent to the partial TCP offload driver 312 where the request is formatted for the partial TCP offload network adapter 316. The partial TCP offload network adapter 316 then sends the request to network line 320. In short, for those requests 301 targeted to partial TCP offload engines, the system configuration described herein allows for the kernel TCP/IP driver 308 to be entirely bypassed resulting in a significant performance increase.

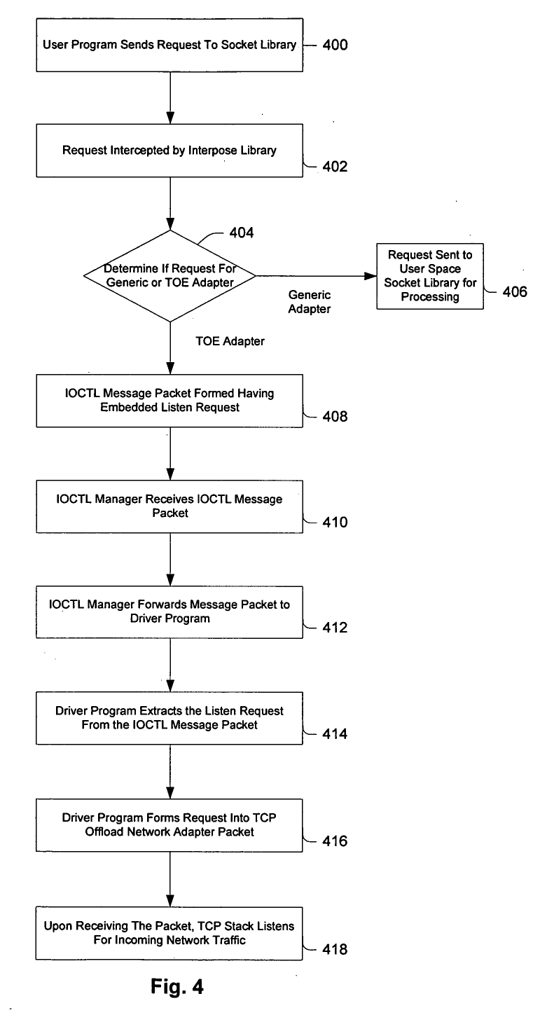

To illustrate the flow of a user application network socket request through the above described system, we now turn to FIG. 4 which illustrates an exemplary handling of a “listen” request. Specifically, a “listen” request that the TCP program “listens” for a network request from a specific computer on the network through the specified computer's IP address and TCP port. The form of a “listen” request is well documented in the art and most user level programmers are familiar with its construction.

As shown in step 400, a user application program transmits a listen request to the generic user space socket library. In accordance with the present invention, the listen request is intercepted by an interposed socket library prior to reaching the user space socket library as illustrated in step 402. In step 404, the interposed socket library determines whether the listen request is directed to a generic network adapter or to a TCP offload engine network adapter. If the listen request is directed to a generic network adapter, the request is forwarded to the user space socket library without modification as depicted in step 406. If, however, the request is directed to the TCP offload engine network adapter, the interposed socket library formats the request into an IOCTL message packet such that the listen request is embedded within the message packet as shown in step 408. The IOCTL message packet is then sent to the IOCTL manager in step 410. The IOCTL manager receives the message packet and forwards the message packet to the full TCP offload interface driver program in step 412. As shown in step 414 interface driver then extracts the embedded listen request from the IOCTL message packet and forms yet another request for the TCP offload engine network adapter. Specifically, as illustrated in step 416, the request formulated by the offload adapter is configured to conform with the TCP stack of the offload engine network adapter. As such, the interface driver transforms the original “listen” request to a format the TCP offload engine network adapter understands. As shown in step 418, once the request has been transformed and delivered to the TCP offload engine network adapter, the TCP stack listens for incoming network traffic from the specified computer of the original “listen” request to the specified TCP Port.

It should be noted that the interposed socket library 202, described with respect to FIG. 2, and the intercepted TCP function router 306, described with respect to FIG. 3, perform equivalent functions, in their respective operating environments, in order to determine which network adaptor is targeted. Specifically, the UNIX operating systems generally implement an “interposed strategy” while Microsoft® operating systems implement a “filter service strategy.” An example of a UNIX operating system is Sun Microsystems' Solaris® 9 operating system. An example of a Microsoft® operating system is Microsoft Windows® XP Professional and Windows® Server 2003. Although FIG. 2 implements an “interposed strategy” with a full TCP/IP offload engine network adapter, FIG. 2 should not be limited to UNIX operating systems. FIG. 2 can also implement a “filter service strategy” with a full TCP/IP offload engine network adapter. FIG. 3 likewise should not be limited to a “filter service strategy” using a Microsoft® operating systems. An “interposed strategy” using a UNIX operating system can be used in FIG. 3 with a partial TCP/IP offload engine network adapter. In short, both the interpose socket library 202 and the intercepted TCP function router 306 act as a filter layer ultimately performing filter functions, implementing the necessary formatting changes, if any, and passing the requests to the appropriate subsequent layer.

While embodiments and implementations of the invention have been shown and described, it should be apparent that many more embodiments and implementations are within the scope of the invention. Accordingly, the invention is not to be restricted, except in light of the claims and their equivalents.

1. A method for processing network requests received by a computer comprising:
intercepting, by an interposed socket library, a request transmitted from an application program;
processing said request to determine whether said request is directed to a generic network adapter or to a TCP offload engine network adapter;
wherein if said request is directed to said TCP offload engine network adapter, directly transmitting said request to said TCP offload engine network adapter for processing thereby bypassing processing by said computer's generic operating system.

2. The method of claim 1, wherein said TCP offload engine network adapter is a full TCP offload engine network adapter.

3. The method of claim 1, wherein said TCP offload engine network adapter is a partial TCP offload engine network adapter.

4. The method of claim 1, wherein said interposed socket library is positioned between said application program and a user space socket library.

5. The method of claim 1, wherein said request is formatted into a standard customizable message passing format enabling said request to be passed between said user space and kernel space in said computer.

6. The method of claim 1, wherein is said request is directed to said generic network adapter, said request is transmitted to a user space socket library for processing.

7. The method of claim 1, wherein said request is an I/O request.

8. A method for processing network requests received by a computer comprising:
intercepting, by an interposed filter, a request transmitted from an application program;
processing said request to determine whether said request is directed to a generic network adapter or to a TCP offload engine network adapter;
wherein if said request is directed to said TCP offload engine network adapter, directly transmitting said request to said TCP offload engine network adapter for processing thereby bypassing processing by said computer's generic operating system.

9. The method of claim 8, wherein said TCP offload engine network adapter is a full TCP offload engine network adapter.

10. The method of claim 8, wherein said TCP offload engine network adapter is a partial TCP offload engine network adapter.

11. The method of claim 8, wherein said interposed filter is positioned in kernel space between a system trap table and a kernel TCP/IP driver.

12. The method of claim 8, wherein said request is formatted into a standard customizable message passing interface in kernel space.

13. The method of claim 8, wherein is said request is directed to said generic network adapter, said request is transmitted to a kernel TCP/IP driver for processing.

14. The method of claim 8, wherein said request is an I/O request.

15. A method for processing network requests received by a computer comprising:
intercepting the transmitted requests at an interposed socket library, said interposed socket library being located between an application program and a user space socket library;
processing said request by said interposed socket library to determine if said request is directed to a generic network adapter or a TCP offload engine network adapter;
wherein if said request is directed to a TCP offload engine network adapter, said request is sent to said TCP offload engine network adapter for processing, thereby bypassing processing by said computer's central processing unit, and
if said request is directed to a generic network adapter, said request is processed by said user space socket library.

16. The method of claim 15, wherein said TCP offload engine network adapter is a full TCP offload engine network adapter.

17. The method of claim 15, wherein said TCP offload engine network adapter is a partial TCP offload engine network adapter.

18. The method of claim 15, wherein said request is formatted into a standard customizable message passing interface between user space and kernel space.

19. The method of claim 15, wherein the request is an I/O request.

20. A computer system for processing network I/O requests comprising:
a computer running an operating system and having access to at least one server computer via a network for receiving I/O requests;
said computer transmitting said I/O requests to an interposed socket library;
said interposed socket library configured to process said I/O requests to determine whether said I/O request is directed to a generic network adapter or to a TCP offload engine network adapter;
wherein if said I/O request is directed to said TCP offload engine network adapter, said I/O request is sent to said TCP offload engine network adapter for processing thereby bypassing processing by said computer's generic operating system processing, and
if said I/O request is directed to said generic network adapter, said I/O request is transmitted to a user space socket library.

21. The system of claim 20, wherein the interposed socket library is positioned between an application program and a user space socket library.

22. A computer program product for enabling a computer to process network I/O requests comprising:
software instructions for enabling the computer to perform predetermined operations, and
a computer readable medium bearing the software instructions;
the predetermined operations including the steps of:
intercepting the transmitted requests at an interposed socket library, said interposed socket library being located between an application program and a user space socket library;
processing said request by said interposed socket library to determine if said request is directed to a generic network adapter or a TCP offload engine network adapter;
wherein if said request is directed to a TCP offload engine network adapter, said request is sent to said TCP offload engine network adapter for processing, thereby bypassing processing by said computer's central processing unit, and
if said request is directed to a generic network adapter, said request is processed by said user space socket library.

23. A computer system adapted to processing network I/O requests, comprising:
a processor;
a memory;
including software instructions adapted to enable the computer system to perform the steps of:
intercepting the transmitted requests at an interposed socket library, said interposed socket library being located between an application program and a user space socket library;
processing said request by said interposed socket library to determine if said request is directed to a generic network adapter or a TCP offload engine network adapter;
wherein if said request is directed to a TCP offload engine network adapter, said request is sent to said TCP offload engine network adapter for processing, thereby bypassing processing by said computer's central processing unit, and
if said request is directed to a generic network adapter, said request is processed by said user space socket library.
